(19) United States
(12) Patent Application Publication
(10) Pub. No.: US 2026/0195832 A1
(43) Pub. Date: Jul. 9, 2026

(54) SYSTEM AND METHODS THEREOF FOR GENERATING REAL-ESTATE PROPERTY ASSESSMENT REPORTS USING RICH COMMUNICATION SERVICES

(71) Applicant: Kaiizen Inc., Glendale, AZ (US)

(72) Inventors: Shane Delamore, Seattle, WA (US); Tov Arneson, New York, NY (US)

(73) Assignee: Kaiizen Inc., Glendale, AZ (US)

(21) Appl. No.: 19/441,242

(22) Filed: Jan. 6, 2026

Related U.S. Application Data
(60) Provisional application No. 63/742,123, filed on Jan. 6, 2025.

(51) Int. Cl. G06Q 50/163; G06F 40/134; H04L 51/08; G06F 3/04847; G06F 40/279

(52) U.S. Cl. CPC G06Q 50/163; G06F 40/134; H04L 51/08; G06F 3/04847; G06F 40/279

(57) ABSTRACT

A method for generating a real-estate property (REP) assessment report using rich communication service (RCS) message, comprising: receiving an electronic message from a user device, wherein the electronic message comprises at least a REP identifier and an assessment request for the REP, wherein the REP identifier uniquely identifies the REP; determining a type of the assessment requested by supplying the electronic message as input to a natural language processing engine; retrieving based on a search of at least one database, augmenting information for the REP, wherein the search is based on at least the REP identifier and the type of the assessment requested; generating, using a message generation module, an RCS message including the requested assessment, wherein the RCS message is generated based on the REP identifier, the type of assessment requested, and the retrieved augmenting information; and transmitting the RCS message toward the user device.

### CROSS REFERENCE TO RELATED APPLICATIONS

This application claims the benefit of U.S. Provisional Application No. 63/742,123 filed on January 6, 2025, the contents of which are incorporated herein by reference.

### TECHNICAL FIELD

The present disclosure relates generally to real-estate assessment tools, and more specifically to a system and method for generating a real-estate property (REP) assessment report using rich communication service (RCS) message.

### BACKGROUND

In the realm of real estate transactions, assessment reports serve as critical documents that provide potential buyers, sellers, and property owners with valuable insights about real-estate properties. These reports often include key information such as property attributes, historical transaction records, market trends, and other relevant data to assist in decision-making.

Traditionally, real-estate property assessment reports are generated manually or rely on static templates. These methods often require significant effort from professionals or users to collect, integrate, and analyze information from various sources. Moreover, the resulting reports are typically generic and fail to dynamically adapt to the specific needs and queries of individual users.

Once an assessment is initiated, users may need to manually sift through extensive property data and perform their own analysis to identify actionable insights. This can be time-consuming and may lead to errors or incomplete information, particularly when multiple properties or complex requirements are involved. Additionally, existing methods often lack interactive and real-time communication capabilities, further limiting their usability and efficiency.

While these conventional approaches provide valuable information, they are not without significant limitations. One major drawback is their inability to dynamically tailor the content of the assessment report to a specific user’s intent or query. Another issue is the lack of integration with modern communication technologies, which could enhance the delivery and usability of property insights through interactive and engaging formats.

It would therefore be advantageous to provide a solution that would overcome the challenges noted above.

### SUMMARY OF THE DISCLOSURE

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for generating a real-estate property (REP) assessment report using a rich communication service (RCS) message. The method comprises receiving, at a computing device, an electronic message from a user device, wherein the electronic message comprises at least an REP identifier and an assessment request for the REP, wherein the REP identifier uniquely identifies the REP; determining, by the computing device, a type of the assessment requested by supplying the electronic message as input to a natural language processing engine; retrieving, by the computing device, based on a search of at least one database, augmenting information for the REP, wherein the search is based on at least the REP identifier and the type of the assessment requested; generating, by the computing device using a message generation module, an RCS message including the requested assessment, wherein the RCS message is generated based on the REP identifier, the type of the assessment requested, and the retrieved augmenting information; and transmitting the RCS message from the computing device toward the user device.

Certain embodiments disclosed herein include a non-transitory computer readable medium having stored thereon instructions for causing a computing device to execute a process for generating a real-estate property (REP) assessment report using a rich communication service (RCS) message, comprising: receiving, at the computing device, an electronic message from a user device, wherein the electronic message comprises at least a REP identifier and an assessment request for the REP, wherein the REP identifier uniquely identifies the REP; determining, by the computing device, a type of the assessment requested by supplying the electronic message as input to a natural language processing engine; retrieving, by the computing device, based on a search of at least one database, augmenting information for the REP, wherein the search is based on at least the REP identifier and the type of the assessment requested; generating, by the computing device using a message generation module, an RCS message including the requested assessment, wherein the RCS message is generated based on the REP identifier, the type of the assessment requested, and the retrieved augmenting information; and transmitting the RCS message from the computing device toward the user device.

Certain embodiments disclosed herein include a system for generating a real-estate property (REP) assessment report using rich communication service (RCS) message, comprising: a processing circuitry; and a memory, the memory containing instructions that, when executed by the processing circuitry, configure the system to: receive an electronic message from a user device, wherein the electronic message comprises at least a REP identifier and an assessment request for the REP, wherein the REP identifier uniquely identifies the REP; determine a type of the assessment requested by supplying the electronic message as input to a natural language processing (NLP) engine; retrieve based on a search of at least one database, augmenting information for the REP, wherein the search is based on at least the REP identifier and type of the assessment requested; generate, using a message generation module (MGM), an RCS message including the requested assessment, wherein the RCS message is generated based on the REP identifier, the type of the assessment requested, and the retrieved augmenting information; and transmit the RCS message toward the user device.

### BRIEF DESCRIPTION OF THE DRAWING

In the drawing:

FIG. 1 is an illustrative network diagram used to describe various disclosed embodiments;

FIG. 2 is an illustrative block diagram of a computing device according to an embodiment; and

FIG. 3 is an illustrative flowchart of a method for generating a real-estate property (REP) assessment report using a rich communication service (RCS) message according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

A method for generating a real-estate property (REP) assessment report using rich communication service (RCS) message is disclosed. The method includes: receiving, using a management server, an electronic message from a user device, the electronic message includes at least a REP identifier and an electronic assessment request for information thereof. The REP identifier uniquely identifies the REP; determining a specific type of assessment requested by feeding the electronic message to a natural language processing (NLP) engine; searching for augmenting information of the REP, the search uses at least the REP identifier and the specific type of assessment requested; generating, using a message generation module, a rich communication service (RCS) message, the RCS message is generated based on the augmenting information; and, transmitting the RCS message to the user device.

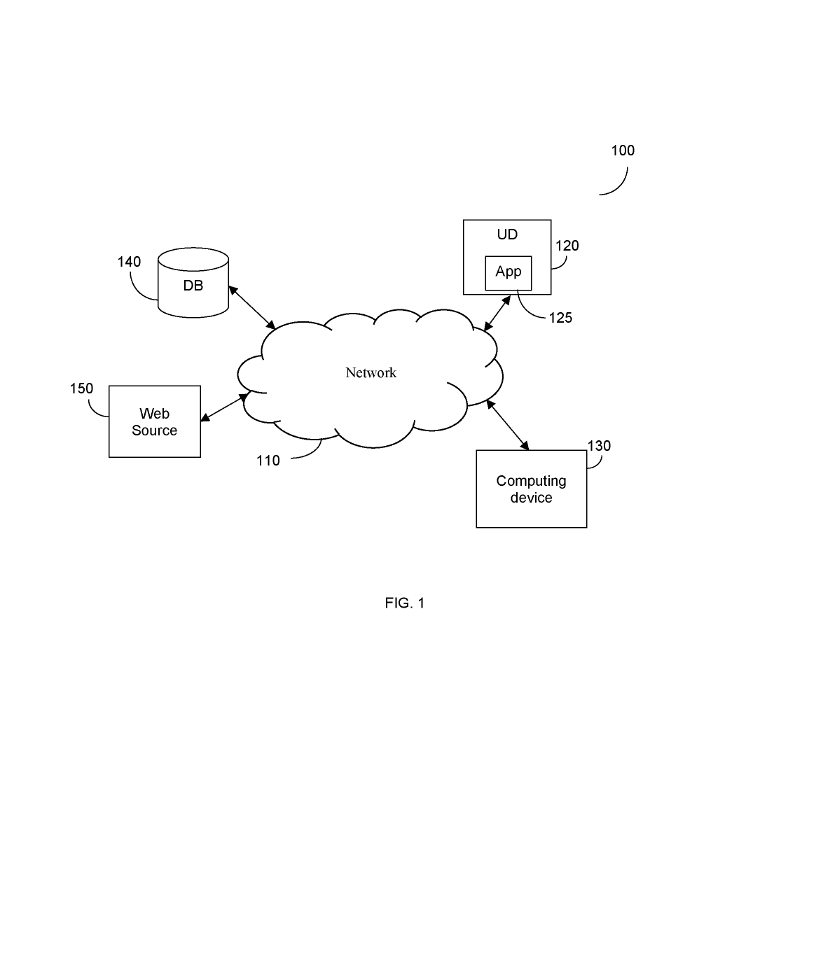

FIG. 1 is an illustrative network diagram 100 used to describe the various disclosed embodiments. In the example network diagram 100, a user device 120, a computing device 130, and a database 140 are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

A user device 120 may be, for example, a personal computer (PC), a personal digital assistant (PDA), a mobile phone, a smart phone, a tablet computer, an electronic wearable device, e.g., glasses, a watch, etc., and other kinds of wired and mobile appliances, equipped with browsing, viewing, capturing, storing, listening, filtering, and managing capabilities enabled as further discussed herein below.

Each user device 120 may further include one or more software applications, such as the software application 125, installed thereon. The application 125 may be pre-installed on the user device 120. For example, the application 125 is a messaging application, web browser, and the like.

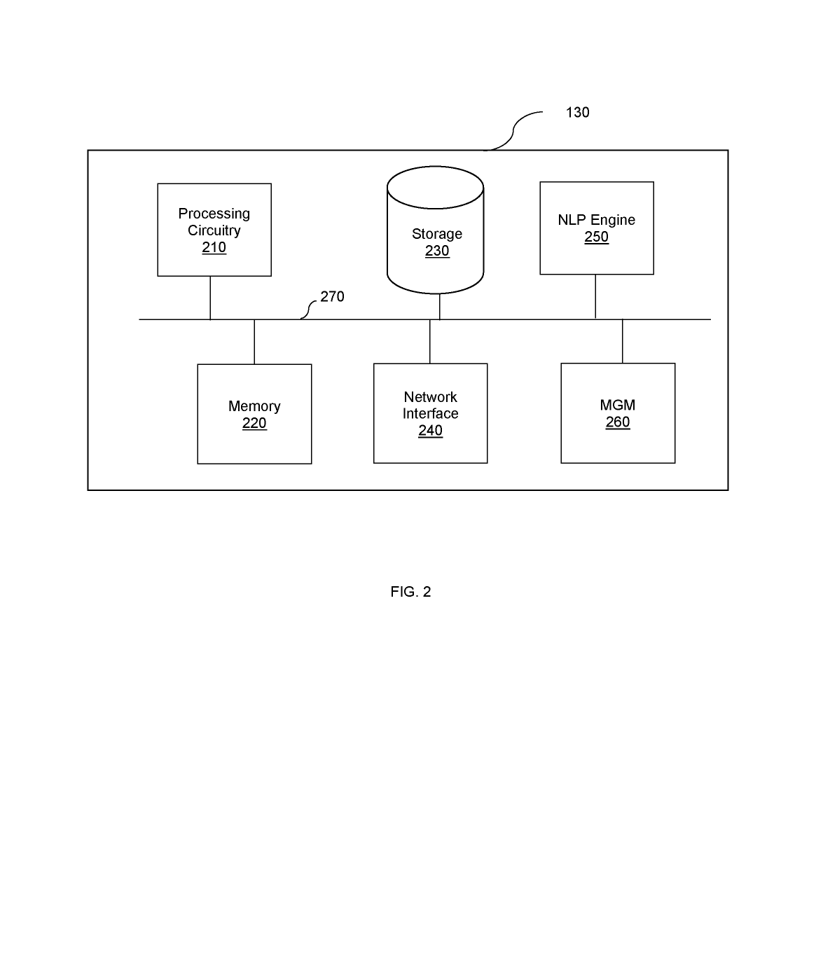

The computing device 130 is connected, over the network 110, to each user device 120 and can communicate therewith using the application 125 via the network 110. In an embodiment, the computing device 130 may be a physical device as illustrated in FIG. 2. In another embodiment, the computing device 130 may be a virtual machine operable in a cloud computing platform. It should be noted that only one user device 120 and one application 125 are discussed herein merely for the sake of simplicity. However, the embodiments disclosed herein are applicable to a plurality of user devices that can communicate with the computing device 130 via the network 110.

In an embodiment, the computing device 130 is configured to receive electronic messages from third-party messaging services via a messaging interface or service account associated with the messaging service. The messaging interface enables programmatic reception of user messages and transmission of RCS messages without requiring installation of a proprietary or system-specific client application associated with the computing device on the user device 120. Such messaging services may include over-the-top messaging platforms that provide application programming interfaces (APIs) or gateway services for message exchange.

As further discussed herein below in detail, the computing device 130 receives an electronic message from a user device 120, the electronic message includes a real-estate property (REP) identifier uniquely identifying a REP and an electronic assessment request. A specific type of assessment requested is determined using a natural language processing (NLP) engine. A search is performed for augmenting information related to the REP. Then, a rich communication service (RCS) message is generated. As used herein, a rich communication service (RCS) message refers to an electronic messaging format that supports transmission of multimedia content and interactive elements beyond plain text, including at least one of images, graphical summaries, interactive controls, and embedded uniform resource locators (URLs). The RCS message includes: (a) concise visual content summarizing key information about the REP, and (b) an embedded uniform resource locator (URL) that, when triggered, directs to an online resource generated based on the augmenting information of the REP, providing detailed and expanded information about the REP. The RCS message is then transmitted to a user device, such as the user device 120.

In an embodiment, the RCS message includes one or more interactive elements configured to enable limited user interaction within the messaging environment. Such interactive elements may include selectable options, buttons, or input controls that allow the user to provide high-level input associated with the requested assessment. Due to constraints inherent to messaging applications, the interactive elements are configured to capture concise interaction signals rather than full assessment manipulation.

User interaction with the interactive elements of the RCS message may trigger generation of a corresponding task-specific online resource identified by a unique uniform resource locator (URL) or modification of an existing online resource associated with the RCS message. The online resource provides an expanded and interactive assessment environment in which additional parameters may be adjusted and assessment results dynamically updated. In this manner, the RCS message operates as a constrained interaction and control layer, while the linked URL functions as a primary execution environment for performing and refining the assessment.

The database 140 is configured to store data and metadata related to REPs, multimedia content, data extracted from regulatory data sources, public data source and/or tax authorities, geographic information systems (GISs), and more. In the embodiment illustrated in FIG. 1, the computing device 130 communicatively communicates with the database 140 through the network 110.

In an embodiment, one or more web sources 150 may be communicatively connected to the computing device 130 via the network 110. The web sources may be, for example, a website, a database, and the like. The web sources may include data regarding REPs.

It should be noted that the embodiments described herein are not limited to the particular configuration illustrated in FIG. 1, and that different configurations may be utilized without departing from the scope of the disclosure. Also, in some implementations, any or all of the components shown in FIG. 1 may communicate directly rather than through a network.

FIG. 2 is an illustrative block diagram 200 of a computing device that is used for generating a real-estate property (REP) assessment report using rich communication service (RCS) message, according to an embodiment.

The computing device 130 includes a processing circuitry 210 coupled to a memory 220, a storage 230, a network interface 240, a natural language processing (NLP) engine 250, and a message generation module (MGM) 260. In an embodiment, the components of the computing device 130 may be communicatively connected via a bus 270.

The processing circuitry 210 may be realized as one or more hardware logic components and circuits. For example, illustrative types of hardware logic components that can be used include field programmable gate arrays (FPGAs), application-specific integrated circuits (ASICs), Application-specific standard products (ASSPs), system-on-a-chip systems (SOCs), GPUs, general-purpose microprocessors, microcontrollers, digital signal processors (DSPs), and the like, or any other hardware logic components that can perform calculations or other manipulations of information.

The memory 220 may be volatile, e.g., RAM, etc., non-volatile, e.g., ROM, flash memory, etc., or a combination thereof. In one configuration, computer-readable instructions to implement one or more embodiments disclosed herein may be stored in the storage 230.

In another embodiment, the memory 220 is configured to store software. Software shall be construed broadly to mean any type of instructions, whether referred to as software, firmware, middleware, microcode, hardware description language, or otherwise. Instructions may include code, e.g., in source code format, binary code format, executable code format, or any other suitable format of code. The instructions, when executed by the processing circuitry 210, cause the processing circuitry 210 to perform the various processes described herein. Specifically, the instructions, when executed, cause the processing circuitry 210 to: receive an electronic message from a user device, the electronic message includes a real-estate property (REP) identifier and an electronic assessment request; analyze the electronic message to determine a specific type of assessment requested; search at least one database for augmenting information of the REP based on the REP identifier and the specific type of assessment requested; generate a rich communication service (RCS) message including concise visual content about the REP and an embedded uniform resource locator (URL) that directs to a dynamically generated online resource with detailed information about the REP; and transmit the RCS message to the user device.

The storage 230 may be magnetic storage, optical storage, and the like, and may be realized, for example, as flash memory or any other medium which can be used to store the desired information.

The network interface 240 allows the computing device 130 to communicate with the different components of the system such as the user device(s) 120, database(s) 140, web source(s) 150, and the like, of FIG. 1. The network interface 240 may further include or be coupled to a messaging gateway configured to communicate with third-party messaging services.

The NLP engine 250 is a software and/or hardware component configured to process and analyze unstructured text data within electronic messages. It utilizes advanced natural language processing techniques to extract key information, identify relevant entities such as the real-estate property (REP) identifier, and classify the type of assessment requested in the message. The NLP engine employs machine learning models, rule-based algorithms, or a combination of both to interpret the semantics and context of the text, enabling accurate mapping of the user's input to actionable parameters. By converting unstructured text into structured outputs, the NLP engine facilitates seamless integration with other components of the computing device 130, ensuring the efficient generation of customized real-estate property assessment reports.

In an embodiment, the NLP engine 250 is configured to process an incoming electronic message using a multi-stage natural language understanding pipeline. The pipeline may include preprocessing of the message content to extract structured elements, including at least one of a real-estate property (REP) identifier, location-related entities, and assessment-related attributes. Based on the extracted elements, the NLP engine 250 performs classification to determine a category of assessment requested by the user, such as a price assessment, renovation assessment, or rental assessment.

In an embodiment, the classification is performed using one or more machine learning models trained on historical user interactions and labeled assessment outcomes. The NLP engine 250 may further generate a confidence score associated with the determined assessment category, and in response to ambiguity or low confidence, apply additional analysis or fallback processing to refine the assessment parameters. The structured output of the NLP engine is provided to downstream components of the computing device to control selection of data sources, search scope, and generation of the assessment report.

The message generation module (MGM) 260 is a software and/or hardware component configured to create rich communication service (RCS) messages based on the processed data received from the natural language processing (NLP) engine 250 and other components of the computing device 130.

It should be understood that the embodiments described herein are not limited to the specific architecture illustrated in FIG. 2, and other architectures may be equally used without departing from the scope of the disclosed embodiments.

In an embodiment, the computing device 130 receives an electronic message from a user device, e.g., the user device 120. The electronic message may be sent from the user device 120 using a messaging application, e.g., the messaging application 125. Such messaging applications may include, for example, WhatsApp®, Telegram®, Signal®, or similar platforms that support electronic communication. That is, the user is not required to download a designated application to communicate with the computing device 130, but may instead, as alluded to hereinabove, communicate using a pre-installed or third-party messaging application installed on the user device. The message may include text, characters, symbols, multimedia, and the like.

The electronic message includes at least a REP identifier and an electronic assessment request for information thereof. The REP identifier may include, for example, the REP address, allowing to uniquely identify the REP.

According to an embodiment, the computing device 130 is configured to process audio messages received from the user device 120. Upon receiving an audio message, the computing device 130 employs an Automatic Speech Recognition (ASR) engine to transcribe the audio content into textual data. The transcribed text is then fed into the NLP engine 250. This integration of ASR and NLP enables the system to seamlessly handle both text-based and audio-based input, providing a comprehensive and versatile assessment framework.

In an embodiment, the computing device 130 determines a specific type of assessment requested by feeding the electronic message to the NLP engine 250. The NLP engine 250 analyzes the content of the electronic message to identify keywords, phrases, or contextual patterns that indicate the nature of the assessment requested. The specific type of assessment requested may include, for example, price assessment, renovation assessment, rental price assessment, or other categories relevant to the user's query.

According to an embodiment, the computing device 130 may process various specific assessment requests using the NLP engine 250. For example, in the case of a price assessment, the user may send an electronic message such as "What is the market value of a three-bedroom house at 123 Main Street, San Francisco, CA?" The NLP engine 250 analyzes the message to extract key details, such as property type and specific location, and determines the specific type of required assessment. Similarly, for a renovation assessment, the user may inquire, "How much would it cost to renovate a 200-square-foot kitchen at 456 Elm Avenue, Los Angeles, CA?". In the case of a rental price assessment, a message like "What is the average monthly rent for an apartment at 789 Oak Street, Manhattan, NY?" is analyzed to determine the required assessment type. These examples demonstrate how the computing device 130 adapts to diverse user queries, leveraging the NLP engine 250 for tailored responses.

According to an embodiment, the NLP engine 250 employs machine learning models to classify the specific type of assessment request included in the electronic message. These machine learning models are trained on historical user queries and their corresponding outputs, allowing the NLP engine 250 to effectively learn patterns, keywords, and contextual relationships that indicate the nature of the assessment requested. For example, the models can differentiate between a price assessment query ("What is the estimated value of my property?") and a renovation assessment query ("How much would it cost to remodel my kitchen?"). The training process incorporates labeled datasets of prior queries, augmented with diverse linguistic structures and regional variations to ensure robustness and accuracy. By leveraging machine learning, the NLP engine 250 enhances its ability to interpret complex and nuanced user assessment requests, ensuring the accurate classification of the assessment type and improving the overall performance of the system.

According to an embodiment, the computing device 130 searches in at least one database, e.g., the database 140 for augmenting information of the real-estate property (REP). The search process utilizes at least the REP identifier and the specific type of assessment requested as search parameters. For example, if the specific type of assessment requested is a price assessment, the computing device 130 queries the database 140 using the REP address, acting as the REP identifier, to retrieve relevant information, such as recent sales data for similar properties, neighborhood statistics, or market trends. In another example, for a renovation assessment, the database query may retrieve typical renovation costs for properties of a similar type, size, and location.

It should be noted that the system significantly optimizes processing time and resource usage by narrowing the search scope to focus on the specific type of required assessment rather than retrieving generalized data about the real-estate property (REP). For example, instead of fetching a broad range of property details, such as historical ownership records, zoning information, or architectural plans, which may not be relevant to the user’s request, the computing device 130 restricts the search to data directly pertinent to the specific assessment type. As noted above, for a price assessment, this might include market trends and comparable property sales, while a renovation assessment might involve retrieving costs associated with similar property renovations. This targeted approach reduces the volume of unnecessary data retrieved, minimizing computational overhead and enabling the system to deliver results more quickly. By focusing on specific data points, the system enhances efficiency, ensuring users receive highly relevant and actionable insights without delays caused by irrelevant information processing.

In an embodiment, such optimization is achieved through early determination of the assessment category prior to retrieval of property-related data. The output of the natural language processing (NLP) engine 250 is used to select a predefined subset of data sources, database indices, and data attributes associated with the determined assessment category, while excluding data sources and attributes unrelated to that category. As a result, the computing device 130 avoids retrieval and processing of generalized property data and limits data access to assessment-specific information at an initial stage of the workflow, rather than performing broad retrieval followed by post-processing or filtering.

According to an embodiment, the computing device 130 includes a data validation module configured to validate the augmenting information retrieved from the database 140. The validation process involves cross-referencing the augmenting information with external trusted sources, such as government property records, professional real estate platforms, or third-party verification services, to ensure the accuracy and reliability of the retrieved data. For example, if the retrieved information includes recent sales data for comparable properties, the data validation module verifies the details against official property transaction records. Similarly, renovation cost estimates may be validated by comparing them with data from certified construction cost databases or similar resources. This cross-referencing mechanism minimizes the risk of inaccurate or outdated information being included in the generated RCS message, thereby enhancing the credibility and reliability of the REP assessment report.

According to an embodiment, the augmenting information is ranked and prioritized based on its relevance to the specific type of assessment requested. A ranking algorithm may be employed to evaluate the retrieved information against predefined criteria, such as recency, accuracy, and contextual alignment with the specific assessment requested. For example, in a price assessment request, recent sales data for comparable properties in the same neighborhood may be given higher priority over older or geographically distant data. Similarly, for a renovation assessment, cost estimates from trusted and frequently updated sources may be ranked higher than less reliable datasets.

According to an embodiment, the computing device 130 utilizes the message generation module (MGM) 260 to generate a rich communication service (RCS) message that is tailored to the specific type of required assessment, based on the augmenting information retrieved from the database 140. The MGM 260 processes the augmenting information to create a customized, concise, and visual message format that includes key insights about the specific type of required assessment of the REP. For example, the RCS message may feature high-level data points such as the estimated property value, a summary of comparable market data, or a cost estimate for a proposed renovation. Additionally, the RCS message may include graphical elements such as charts, tables, or images to enhance the user's understanding of the information. By tailoring the RCS message to the specific type of assessment requested, the MGM 260 ensures that the message delivers actionable and contextually relevant insights to the user in an efficient and engaging manner.

According to an embodiment, the RCS message generated by the MGM 260 includes two main components. First, the RCS message includes concise visual content summarizing key information about the REP. This summary highlights features relevant to the specific type of assessment requested, such as estimated property value for a price assessment, renovation costs for a renovation assessment, average rental prices for a rental price assessment, and the like. The visual content may include graphs, tables, or infographics to provide a clear and immediate understanding of the information.

Second, the RCS message incorporates an embedded uniform resource locator (URL). The URL, when triggered by the user, directs to a dynamically generated online resource that offers detailed and expanded information about the REP. This online resource is customized based on the retrieved REP data and the specific type of assessment requested. For example, in the case of a price assessment, the online resource may include comparable sales, historical pricing trends, and neighborhood statistics. By combining concise visual content with an interactive URL, the RCS message delivers a seamless and enriched user experience, enabling quick access to both high-level summaries and in-depth analyses tailored to the user’s needs.

According to an embodiment, the rich communication service (RCS) message generated by the message generation module (MGM) 260 further includes interactive elements that allow the user to refine the assessment parameters or request additional information. These interactive elements may include, but are not limited to, buttons, drop-down menus, or sliders embedded within the RCS message. For example, a user receiving a price assessment report may interact with a slider to adjust the estimated property value based on potential renovations or market fluctuations. Similarly, a button may enable the user to specify additional parameters, such as property size, age, and the like, for a more tailored assessment.

According to an embodiment, the dynamically generated online resource, accessible via the embedded URL in the RCS message, includes interactive elements that allow the user to refine the assessment parameters or request additional information. These interactive elements may include adjustable filters, expandable data visualizations, or input fields for specifying new criteria. For example, within the online resource for a price assessment, users can modify parameters to view updated property valuations. Similarly, in the case of a renovation assessment, the user can adjust the renovation scope to dynamically update the cost estimates. These interactive features enable the user to explore customized insights and make more informed decisions by engaging directly with the data presented in the online resource.

According to an embodiment, the computing device 130 transmits the generated RCS message to the user device 120. Once the MGM 260 finalizes the RCS message, it is passed to the network interface 240, which facilitates its delivery. The network interface 240 utilizes communication protocols compatible with RCS messaging standards to ensure seamless and efficient transmission.

The transmission ensures that the user receives the RCS message promptly, containing concise visual content summarizing key insights and an embedded URL for accessing detailed and expanded information. By leveraging advanced communication technologies, the system ensures that the user device 120 receives the assessment results in a clear and actionable format, enhancing the overall user experience and enabling informed decision-making with minimal latency.

According to an embodiment, feedback is received from the user device 120 regarding the generated RCS message. This feedback may include user-provided comments, ratings, or interaction metrics, such as how long the user engaged with the message or whether they accessed the embedded uniform resource locator (URL). The feedback is processed by the computing device 130 to identify areas for improvement in subsequent assessment reports. For instance, if a user provides feedback indicating that certain data points were unclear or irrelevant, the system can adjust its data retrieval and message generation processes to better align with user expectations. Similarly, feedback about additional information requests, such as neighborhood insights or detailed renovation breakdowns, may guide enhancements to the dynamically generated online resource. By leveraging user feedback, the system continuously evolves to deliver more accurate, relevant, and user-friendly assessment reports.

In an embodiment, the computing device 130 is further configured to receive feedback associated with a generated assessment report, including at least one of user interaction data, user-provided input, or outcome-related signals. The feedback may be analyzed to identify patterns indicative of assessment relevance, accuracy, or usability. Based on the analyzed feedback, the computing device 130 may adjust one or more parameters employed in subsequent assessment generation, including at least one of data source selection, search scope, weighting of augmenting information, or configuration of assessment presentation. In this manner, the system operates as a feedback-driven assessment framework in which subsequent assessments are adaptively influenced by prior user interactions.

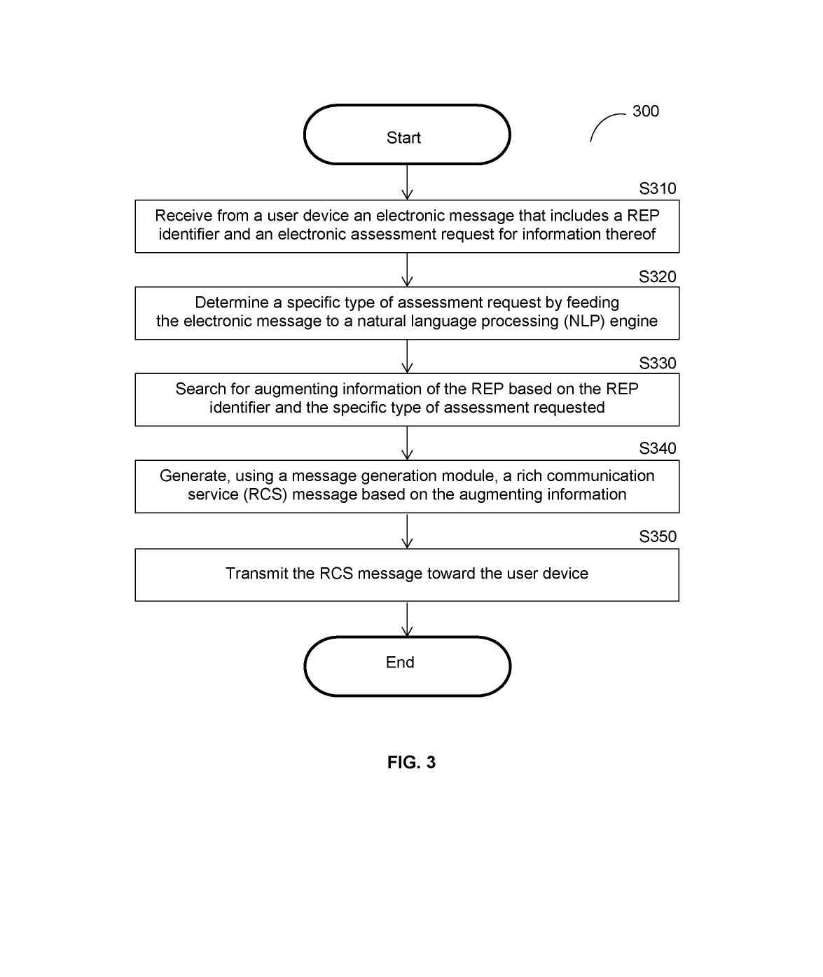

FIG. 3 an illustrative flowchart of a method 300 illustrating a method for generating and transmitting a real-estate property (REP) assessment report as a rich communication service (RCS) message, according to an embodiment. The method may be performed by the computing device 130 in conjunction with its various components, as described in FIGS. 1 and 2.

At S310, an electronic message is received from a user device, e.g., the user device 120, of FIG. 1. The electronic message includes a REP identifier and an electronic assessment request for information thereof. The REP identifier may include, for example, the REP address, which uniquely identifies the property. The electronic message may be sent using a messaging application such as WhatsApp®, Telegram®, Signal®, and the like, ensuring user convenience by eliminating the need to download a dedicated application.

At S320, the specific type of assessment requested is determined by feeding the electronic message to a natural language processing (NLP) engine. The content of the electronic message is analyzed to identify keywords, phrases, or contextual patterns that indicate the nature of the assessment requested. Examples of assessment types include price assessment, renovation assessment, rental price assessment, and so on.

At S330, a search is conducted in at least one database, e.g., the database 140, for augmenting information of the REP. The search process utilizes the REP identifier and the specific type of assessment requested as search parameters. The focused search reduces processing time and guarantees the retrieval of relevant information only.

At S340, a rich communication service (RCS) message is generated using a message generation module (MGM), based on the augmenting information. The RCS message is tailored to the specific type of required assessment and includes concise visual content summarizing key insights. Additionally, the RCS message includes an embedded uniform resource locator (URL) that directs the user to a dynamically generated online resource containing detailed and expanded information about the REP.

At S350, the RCS message is transmitted to the user device, e.g., the user device 120. The RCS message provides actionable insights and a convenient link for accessing detailed analysis, enabling informed decision-making in real time.

The method described in FIG. 3 demonstrates an efficient and user-friendly approach to generating customized REP assessment reports. By leveraging advanced natural language processing, targeted database searches, and rich communication services, highly relevant and visually engaging results are delivered to users, tailored to their specific needs.

The various embodiments disclosed herein can be implemented as hardware, firmware executing on hardware, software executing on hardware, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform, such as an additional data storage unit and a printing unit. Furthermore, a non-transitory computer-readable medium is any computer-readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating a real-estate property (REP) assessment report using a rich communication service (RCS) message, comprising:
receiving, at a computing device, an electronic message from a user device, wherein the electronic message comprises at least an REP identifier and an assessment request for the REP, wherein the REP identifier uniquely identifies the REP;
determining, by the computing device, a type of the assessment requested by supplying the electronic message as input to a natural language processing engine;
retrieving, by the computing device, based on a search of at least one database, augmenting information for the REP, wherein the search is based on at least the REP identifier and the type of the assessment requested;
generating, by the computing device using a message generation module, an RCS message including the requested assessment, wherein the RCS message is generated based on the REP identifier, the type of the assessment requested, and the retrieved augmenting information; and
transmitting the RCS message from the computing device toward the user device.

2. The method of claim 1, wherein the RCS message comprises at least one of visual content summarizing key information about the REP and highlighting of at least one feature of the REP relevant to the type of assessment requested.

3. The method of claim 1, wherein the RCS message comprises an embedded uniform resource locator (URL) that directs to a dynamically generated online resource that provides further information about the REP based on the retrieved augmenting information and the type of assessment requested.

4. The method of claim 3, wherein the dynamically generated online resource further includes interactive elements.

5. The method of claim 4, wherein the dynamically generated online resource further includes at least one interactive element, the at least one interactive element enabling the user to at least one of: refine at least one parameter employed in developing the requested assessment and request additional information.

6. The method of claim 1, further comprising validating the augmenting information retrieved from the database using a data validation module, wherein the validation includes cross-referencing the augmenting information with external trusted sources to ensure data accuracy and reliability.

7. The method of claim 1, wherein the natural language processing engine employs at least one machine learning model to classify the type of assessment requested, wherein the machine learning model is trained on historical user queries and their corresponding outputs.

8. The method of claim 1, wherein the RCS message further includes at least one interactive element, wherein the at least one interactive element enables the user to at least one of: refine at least one parameter employed in developing the requested assessment and request additional information.

9. The method of claim 1, further comprising receiving feedback from the user device about the generated RCS message, wherein the feedback is employed as a basis to improve at least one subsequent RCS message that includes a subsequent assessment report in response to a subsequent assessment request.

10. A non-transitory computer-readable medium having stored thereon instructions for causing a computing device to execute a process for generating a real-estate property (REP) assessment report using a rich communication service (RCS) message, comprising:
receiving, at the computing device, an electronic message from a user device, wherein the electronic message comprises at least a REP identifier and an assessment request for the REP, wherein the REP identifier uniquely identifies the REP;
determining, by the computing device, a type of the assessment requested by supplying the electronic message as input to a natural language processing engine;
retrieving, by the computing device, based on a search of at least one database, augmenting information for the REP, wherein the search is based on at least the REP identifier and the type of the assessment requested;
generating, by the computing device using a message generation module, an RCS message including the requested assessment, wherein the RCS message is generated based on the REP identifier, the type of the assessment requested, and the retrieved augmenting information; and
transmitting the RCS message from the computing device toward the user device.

11. A system for generating a real-estate property (REP) assessment report using rich communication service (RCS) message, comprising:
a processing circuitry; and
a memory, the memory containing instructions that, when executed by the processing circuitry, configure the system to:
receive an electronic message from a user device, wherein the electronic message comprises at least a REP identifier and an assessment request for the REP, wherein the REP identifier uniquely identifies the REP;
determine a type of the assessment requested by supplying the electronic message as input to a natural language processing (NLP) engine;
retrieve based on a search of at least one database, augmenting information for the REP, wherein the search is based on at least the REP identifier and type of the assessment requested;
generate, using a message generation module (MGM), an RCS message including the requested assessment, wherein the RCS message is generated based on the REP identifier, the type of the assessment requested, and the retrieved augmenting information; and
transmit the RCS message toward the user device.

12. The system of claim 11, wherein the RCS message comprises at least one of visual content summarizing key information about the REP and highlighting of at least one feature of the REP relevant to the type of assessment requested.

13. The system of claim 11, wherein the RCS message comprises an embedded uniform resource locator (URL) that directs to a dynamically generated online resource that provides further information about the REP based on the retrieved augmenting information and the type of assessment requested.

14. The system of claim 13, wherein the dynamically generated online resource further includes interactive elements.

15. The system of claim 14, wherein the dynamically generated online resource further includes at least one interactive element, the at least one interactive element enabling the user to at least one of: refine at least one parameter employed in developing the requested assessment and request additional information.

16. The system of claim 11, wherein the processing circuitry is further configured to validate the augmenting information retrieved from the database using a data validation module, wherein the validation includes cross-referencing the augmenting information with external trusted sources to ensure data accuracy and reliability.

17. The system of claim 11, wherein the natural language processing engine employs at least one machine learning model to classify the type of assessment requested, wherein the machine learning model is trained on historical user queries and their corresponding outputs.

18. The system of claim 11, wherein the RCS message further includes at least one interactive element, wherein the at least one interactive element enables the user to at least one of: refine at least one parameter employed in developing the requested assessment and request additional information.

19. The system of claim 11, wherein the processing circuitry is further configured to receive feedback from the user device about the generated RCS message, wherein the feedback is employed as a basis to improve at least one subsequent RCS message that includes a subsequent assessment report in response to a subsequent assessment request.
